(19) United States
(12) Patent Application Publication
(10) Pub. No.: US 2014/0156768 A1
(43) Pub. Date: Jun. 5, 2014

(54) METHODS AND SYSTEMS FOR REAL-TIME PAGING

(71) Applicant: Avaya Inc., Basking Ridge, NJ (US)

(72) Inventors: THIRUNAVUKKARASU ARJUNAN, Bangalore (IN); VINOD SULLERI PUTTASWAMY, Bangalore (IN); RAMANUJAN S. KASHI, Bangalore (IN)

(21) Appl. No.: 13/931,391

(22) Filed: Jun. 28, 2013

Related U.S. Application Data
(60) Provisional application No. 61/732,040, filed on Nov. 30, 2012.

(51) Int. Cl. H04L 12/58

(52) U.S. Cl. CPC H04L 51/04
USPC 709/206

(57) ABSTRACT

The present disclosure is directed to methods for sending a real-time message to a recipient, where the sending is accomplished using a pre-existing communication system in communication with at least one of multiple application gateways or multiple networks, and systems including a paging engine; a first application gateway; and an administrative portal; where the paging engine, the first application gateway, and the administrative portal are configured to send a real-time message to a recipient, where the sending is accomplished a pre-existing communication system in communication with at least one of multiple application gateways or multiple networks.

### RELATED U.S. PATENT APPLICATION DATA

This application claims the benefit under 35 U.S.C. §119(e) of U.S. Provisional Application No. 61/732,040, filed Nov. 30, 2012 entitled “METHODS AND SYSTEMS FOR REAL-TIME PAGING.”

### FIELD

The disclosure relates generally to notification methods and systems and particularly to methods and systems for real-time paging.

### BACKGROUND

Previously existing paging systems provide the ability to send and receive messages to one or more endpoints. The messages may be in various formats, including text, video, and audio. For example, recorded audio messages may be sent to the voicemail of other users. Another common message format is short message service (SMS), which is a form of text message communication on phones and mobile devices through service providers. Yet another example of a previously existing paging system is a building notification system that uses specialized hardware and enables audio to be played on speakers mounted in buildings.

However, previously existing paging systems have many problems. They either do not have the ability to send real-time messages; do not have the ability to send real-time audio messages with text, image, or video attached; do not have the ability to send messages using certain groups and/or priorities; and/or have problems in integrating existing messaging capabilities with messaging needs. For example, many broadcasting systems suffer from audio quality issues, and problems with integrating existing equipment with messaging needs to achieve adequate performance. Further, previous paging systems that can broadcast an audio message over speakers have problems due to hardware compatibility issues causing poor quality of the audio output (e.g., issues with compatibility of digital, analog, or IP speakers).

### SUMMARY

These and other needs are addressed by the various embodiments and configurations of the present disclosure.

The following presents a simplified summary of the disclosure to provide an understanding of some aspects of the disclosure. This summary is not an extensive overview of the disclosure and its various embodiments. It is intended neither to identify key or critical elements of the disclosure nor to delineate the scope of the disclosure but to present selected concepts of the disclosure in a simplified form as an introduction to the more detailed description presented below.

The present disclosure(s) is directed generally to methods for sending a real-time message to a recipient, where the sending is accomplished using a pre-existing communication system in communication with at least one of multiple application gateways or multiple networks. The present disclosure(s) is also directed generally to systems including a paging engine; a first application gateway; and an administrative portal; where the paging engine, the first application gateway, and the administrative portal are configured to send a real-time message to a recipient, where the sending is accomplished using a pre-existing communication system in communication with at least one of multiple application gateways or multiple networks.

These and other advantages will be apparent from the disclosure of the disclosure(s) contained herein.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

It is to be noted that the term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic even if performance of the process or operation uses human input, whether material or immaterial, received before performance of the process or operation. Human input is deemed to be material if such input influences how the process or operation will be performed. Human input that consents to the performance of the process or operation is not deemed to be “material”.

The terms “determine”, “calculate” and “compute,” and variations thereof, as used herein, are used interchangeably and include any type of methodology, process, mathematical operation or technique.

The term “computer-readable medium” as used herein refers to any tangible storage and/or transmission medium that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

The term “module” as used herein refers to any known or later developed hardware, software, firmware, artificial intelligence, fuzzy logic, or combination of hardware and software that is capable of performing the functionality associated with that element. Also, while the disclosure is described in terms of exemplary embodiments, it should be appreciated that individual aspects of the disclosure can be separately claimed.

The term “social network” means a grouping of people having a common characteristic, such as having common interests, passions, beliefs, experiences, and/or needs. The characteristic may be positive or negative. For example, pro-republican persons are members of a pro-republican party social network infrastructure while anti-republication persons are members of an anti-republican social network. In one configuration, at least most of the social network structure members do not know one another personally, are not employed by a common business entity, and are also members of the general public. In another configuration, the social network is a social structure made of nodes which are generally individuals or organizations. It indicates the ways in which they are connected through various social familiarities ranging from casual acquaintance to close familial bonds.

The term “paging” means messaging or notifying a user at an endpoint. Paging, or messaging, may include, but is not limited to, text messages, audio messages (including voice messages), image messages, and video messages.

The above-described embodiments and configurations are neither complete nor exhaustive. As will be appreciated, other embodiments of the disclosure are possible utilizing, alone or in combination, one or more of the features set forth above or described in detail below.

### BRIEF DESCRIPTION OF THE DRAWINGS

FIG. 1 is a block diagram of an architecture according to embodiments of the present disclosure;

FIG. 2 is a block diagram of an architecture according to embodiments of the present disclosure;

FIG. 3 is a flowchart according to embodiments of the present disclosure;

FIG. 4 is a flowchart according to embodiments of the present disclosure;

FIG. 5 is a screenshot according to embodiments of the present disclosure;

FIG. 6 is a screenshot according to embodiments of the present disclosure;

FIG. 7 is a screenshot according to embodiments of the present disclosure;

FIG. 8 is a screenshot according to embodiments of the present disclosure;

FIG. 9 is a screenshot according to embodiments of the present disclosure;

FIG. 10 is a screenshot according to embodiments of the present disclosure;

FIG. 11 is a screenshot according to embodiment of the present disclosure;

FIG. 12 is a screenshot according to embodiments of the present disclosure; and

FIG. 13 is a screenshot according to embodiments of the present disclosure.

### DETAILED DESCRIPTION

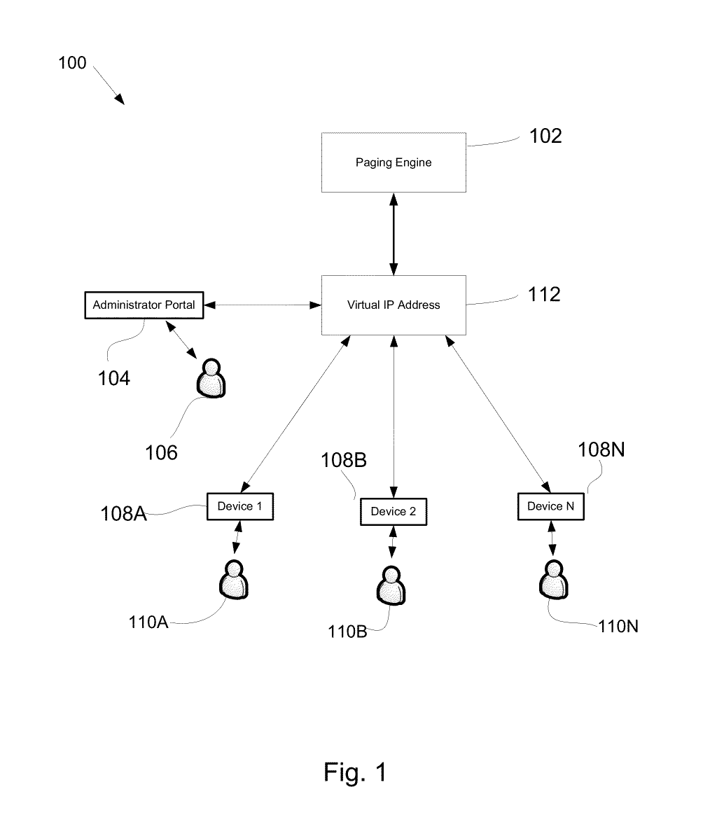

FIG. 1 is a block diagram depicting components of a paging system 100 in accordance with embodiments of the present disclosure. In particular, the paging system 100 includes a paging engine 102, a virtual IP address 112, an administrator portal 104, an administrator 106, a device 1 108A, a device 2 108B, a device N 108N, and users 110A, 110B, and 110N.

The paging engine 102 performs functionality for paging and can be an encapsulated block of software and/or hardware having such functionality. For example, the paging engine 102 may configure and transmit in real-time audio, text, images, video, and/or other data messages to one or more endpoints. The endpoints (e.g., receivers) may include a pager, a telephone, a softphone, a mobile device, or computer applications, among others. Although a single paging engine 102 is shown, a paging system 100 can have any number of paging engines 102. Multiple paging engines may advantageously enable improved availability and redundancy of the system so that if one paging engine fails, then real-time message requests may be handled by another paging engine.

The paging engine 102 may also be referred to as a gateway application or server, and may include one or more gateway applications and/or servers. Further, the paging engine 102 may have the capability to interface with pre-existing communication equipment; e.g., pre-existing call servers, pre-existing paging servers, and pre-existing broadcast systems. For example, paging system 100 may function to make a real-time announcement using a pre-existing broadcast system, where the real-time audio announcement is broadcast on an equipment's speaker using a one-way speech path. Further, paging system 100 may allow real-time messages to be sent based on privacy demands; for example, tailoring the type of pre-existing equipment to which to deliver the real-time message based on a privacy requirement of the message.

The virtual IP address (VIP) 112 can be an IP address assigned to a single server, a network interface card, multiple applications on a single server, multiple domain names, or multiple servers, for example. The VIP 112 can receive and route data packets to and from various endpoints or network interfaces. In FIG. 1, the VIP 112 may route data from the paging engine 112 to device 1 108A, device 2 108B, and device N 108N. In embodiments, the VIP 112 can enable hosting for several different applications and/or virtual applications on a server with only one logical IP address. VIP 112 may be used for connection redundancy by providing fail-over options on a machine; for example, a VIP address may still be available if a computer or network interface card fails because an alternative computer or network interface card may reply to connections. Also, because the paging engine 102 is in communication with the VIP 112, a real-time messaging session may always be active, even upon the failure of the paging engine 102 or a call server. Although a single VIP 112 is shown, a paging system 100 can have any number of VIPs 112.

An administrator 106 may communicate with the VIP 112 through an administrator portal 104. The administrator 106 can perform various functions; for example, configuration of endpoints (e.g., the configuration of users and groups), as well as configuration and management of real-time messages. Particular examples include creating users, defining groups, and managing real-time messages. For example, if the administrator 106 is on the premises of the paging system 100, communications with the VIP 112 may be over a portion of the paging system 100 including a wireless (e.g., a Wi-Fi) network. As another example, the administrator 106 may be in communication with the VIP 112 over the paging system 100, for example via a cellular telephony data network, a Wi-Fi or a wired Ethernet connection outside of the paging system 100. In addition, the administrator portal 104 provides functionality that allows an administrator (or other user) to monitor the paging system 100, and/or to control aspects of the operation of the paging system 100. Although a single administrator 106 and a single administrator portal 104 are shown, a paging system 100 can have any number of administrators 106 and administrator portals 104.

The administrator portal 104 can include any device, including a mobile device, capable of presenting information to an administrator 106, and of receiving control commands from the administrator 106. In addition, the administrator portal 104 is generally a device capable of running an application that provides a browser, template or framework for displaying information and receiving input with respect to such information. In addition, the administrator portal 104 is a device that is capable of wired or wireless communications over at least one of a variety of network types, including but not limited to cellular data networks (such as 3G or 4G networks), Wi-Fi networks, WiMax networks, Bluetooth connections, Ethernet networks, and the like. Accordingly, an administrator portal 104 can include, but is not limited to, a desktop computer, a tablet computer, a laptop computer, a Smartphone, a Netbook, a desktop computer, or the like.

Users 110A, 110B, and 110N may communicate with VIP 112 through device 1 108A, device 2 108B, and device N 108N, for each user respectively. Users 110A, 110B, and 110N can receive real-time messages through device 1 108A, device 2 108B, and device N 108N, respectively. Device 1 108A, device 2 108B, and device N 108N can be various devices or combinations of devices, including a mobile device, capable of presenting information to a respective user, and of receiving control commands from a respective user. In addition, device 1 108A, device 2 108B, and device N 108N may generally each be a device capable of running an application that provides a browser, template or framework for displaying information and receiving input with respect to real-time paging. In addition, device 1 108A, device 2 108B, and device N 108N can each be capable of wired or wireless communications over at least one of a variety of network types, including but not limited to cellular data networks (such as 3G or 4G networks), Wi-Fi networks, WiMax networks, Bluetooth connections, Ethernet networks, and the like. Accordingly, device 1 108A, device 2 108B, and device N 108N can include, but are not limited to, a desktop computer, a tablet computer, a laptop computer, a Smartphone, a Netbook, or the like.

Users 110A, 110B, and 110N may be located in various areas and have various job functions and other properties associated with their profiles. In embodiments, priorities may be associated with specific users and these priorities may be set by an administrator or a user, based on the properties of the user. For example, user 110A may have a high priority due to their job function; user 110B may have a low priority based on the fact that they are currently out of the country on vacation; and user 110N may have a priority associated with a membership to which they belong. In addition, users 110A, 110B, and 110N may be set in groups (also called zones) to assist in configuring the transmission of real-time messages. More specifically, groups can be a set of users. For example, other users with job functions similar to user 110A may be placed in the same group as user 110A, and all users in this group may have a high priority due to their job function.

In addition, paging system 100 can enable group paging requirements in enterprises where the paging system 100 is built on the existing communications infrastructure of call servers and end points (e.g., physical phones and softphones). A group may be set by administrator 106, and may include multiple users. Groups may be set to a predefined group, or dynamically created.

As a particular example, a common requirement in emergency situations is to notify one or many users of vital information through voice or text in real-time. Due to the importance of such messages, it may be necessary to attach a priority to the real-time message in order to enable the higher priority information to be communicated to the end users. Thus, paging system 100 may send user 110B a high-priority message due to a severe weather event (e.g., a tsunami) based on user 110B's location while on vacation.

Other functions available to an administrator 106 are described herein and include, but are not limited to, initiating paging to specific and/or multiple groups or users with a certain priority; configuring IP sets; rendering a presence status on various endpoints, dynamically updating a messaging session status at various endpoints; overriding point-to-point calls with real-time messages based on a priority; using multicast routing; providing group messaging capability during a call server failure; performing multimodal real-time messaging (including text, image, and recorded and live audio and/or video); acknowledging a messaging session from any endpoint (including administrative endpoint); stopping an active or ongoing messaging session from a higher priority user; updating sender information for the message at endpoints (including, for example, name, extension number, designation, and number and identification of groups selected); and stopping the receipt of a message on an endpoint. Groups may include a multicast audio transmitter or receiver, and endpoints may send multicast real-time transport protocol (RTP) based media. In embodiments, real-time group paging using multicast routing may advantageously reduce network traffic and address scalability.

Further, users 110A, 110B, and 110N may be able to perform administrative functions; for example, configuration of IP sets and endpoints (e.g., the configuration of users and groups), as well as configuration and management of real-time messages. For example, if users 110A, 110B, and 110N are on the premises of the paging system 100, communications with the VIP 112 may be over a portion of the paging system 100 including a wireless (e.g., a Wi-Fi) network. As another example, users 110A, 110B, and 110N may be in communication with the VIP 112 over the paging system 100, for example via a cellular telephony data network, a Wi-Fi or a wired Ethernet connection outside of the paging system 100. In addition, device 1 108A, device 2 108B, and device N 108N may provide functionality that allows users 110A, 110B, and 110N, respectively, to monitor the paging system 100, and/or to control aspects of the operation of the paging system 100.

Still further, a message may be sent to a group using different and/or distinct communication modes, where the message may be initiated by sending a command to a server and the server contacts other communication servers that connect to different endpoints over different networks to send the message. In embodiments, the message may be a single message that is sent over different networks to different endpoints. For example, with respect to FIG. 1, the paging engine 102 and virtual IP address 112 may comprise multiple gateways and servers, and devices 1 108A, 108B, and 108N may each be located on different networks distinct from each other. The administrator 106 may initiate a message to each of users 110A, 110B, and 110N, where devices 108A, 108B, and 108N use different communication modes to deliver the message to users 110A, 110B, and 110N, respectively. Thus, administrator 106 sends a command to send a message to the paging engine 102 via the administrator portal 104, and the paging engine 102 contacts the servers associated with devices 108A, 108B, and 108N and their respective networks, for example via virtual IP address 112, to deliver the message in real-time to users 110A, 110B, and 110N via devices 108A, 108B, and 108N, respectively. Thus, users 110A, 110B, and 110N would receive the message in real-time via devices 108A, 108B, and 108N, respectively, in different communication modes and over different networks and via different servers.

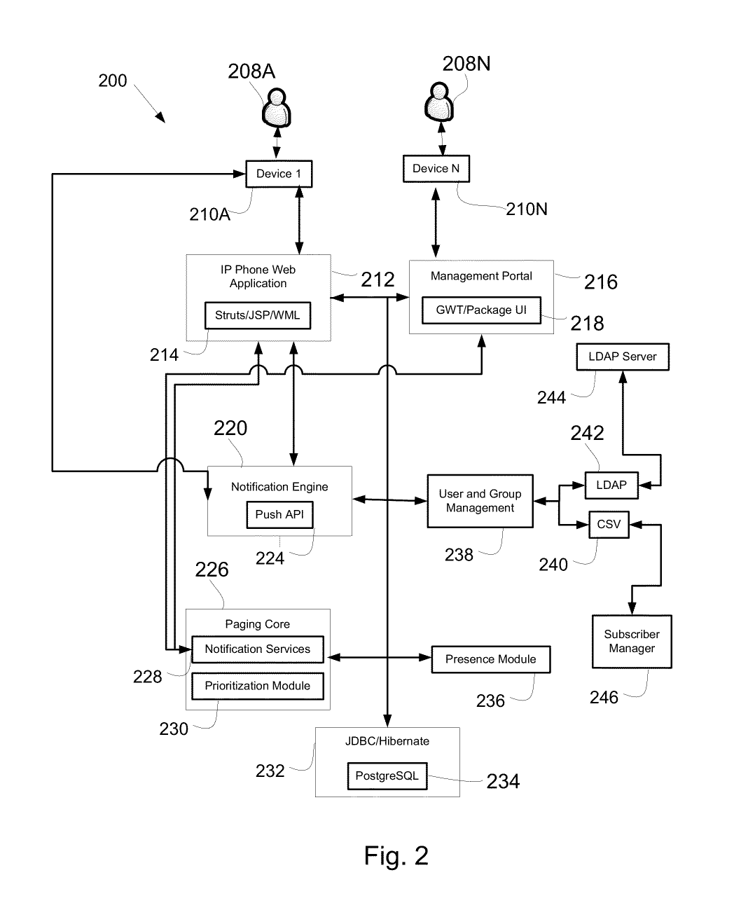

FIG. 2 is a block diagram depicting components of a paging system 200 in accordance with embodiments of the present disclosure. In particular, the paging system 200 includes users 208A and 208N of device 1 210A and device N 210N, respectively, an IP phone web application 212 including a Struts/Java Server Pages (JSP)/Wireless Markup Language (WML) component 213, a management portal 216 including a Google Widget Toolkit (GWT)/Package user interface (UI) component 218, a notification engine 220 including a push application programming interface (API) 224, a user and group management component 238, a lightweight directory access protocol (LDAP) component 242, a LDAP server 244, a comma-separated values (CSV) component 240, a subscriber manager component 246, a paging core 226 including a notification services component 228 and a prioritization module 230, a presence module 236, and a java database connectivity (JDBC)/Hibernate component 232 including a postgreSQL component 234. The components in FIG. 2 may connect via wired or wireless communications over at least one of a variety of network types, including but not limited to local area networks, wide area networks, cellular data networks (such as 3G or 4G networks), Wi-Fi networks, WiMax networks, Bluetooth connections, Ethernet networks, and the like.

The user and group management component 238 can manage endpoint profiles (e.g., 208A and 208N in conjunction with 210A and 210N, respectively), user access, and real-time messaging, including monitoring the paging system 200, and/or controlling aspects of the operation of the paging system 200. There are various ways to manage endpoint/user (e.g., subscriber) details; for example, the subscriber profiles of the endpoints may be imported from the LDAP server 244 as LDAP components 242, or they may be obtained from the subscriber manager 246 as CSV components 240. The LDAP components include directory information maintained by LDAP server using LDAP (an application protocol for accessing and maintaining directory information services over an IP network. Directory services may provide any organized set of records, for example with a hierarchical structure, such as a corporate email directory. CSV components 240 include CSV files, which store tabular data (numbers and text) in plain-text form consisting of any number of records, separated by line breaks of some kind. Thus, the subscriber manager 246 and LDAP server 244 manage profiles of endpoints (e.g., first name and last name, location, etc.), and from these components, entire profiles may be exported by an application gateway for use in paging system 200. In addition, presence module 236 contains presence information regarding endpoints. For example, presence module 236 can obtain an on or off hook status and a messaging or paging status. Presence information from presence module 236 may be used in conjunction with the other components of paging system 200, as described herein. In embodiments, the notification engine 220 receives endpoint details via the push API component 224, which is a software component interface enabling communication via specifications for routines, data structures, object classes, and variables.

In embodiments, the user and group management component 238 can manage endpoint profiles (e.g., 208A and 208N in conjunction with 210A and 210N, respectively) and user access. In addition, the user and group management component 238 can define a range of multicast groups such that when an initiator sends a real-time message request, the application gateway can determine the multicast group (e.g., a combination of multicast IP addresses and phone numbers), and then ask the endpoint to join in the multicast group. Further, the user and group management component 238 can manage a range of multicast IP address and phone numbers so that the application gateway may keep selecting a group of multicast addresses for different real-time messaging sessions. For example, the user and group management component 238 and/or application gateway may choose certain types of endpoints to determine different multicast addresses for different real-time messaging sessions.

The paging core 226 has various functionalities, including a prioritization module 230 and a notification service 228. When a messaging request is initiated from an endpoint (e.g., device 1 210A or device N 210N), the paging core 226 can determine existing paging sessions, whether to override any existing sessions, and can send a HTTP notification feature to inquire the database for receiving endpoint details (e.g., IP address and IP address information) in order to formulate a push message and then push the messages onto the endpoints.

For example, a push initiator (e.g., an IP phone application or PPE) is capable of transmitting a push message to a push agent (e.g., IP endpoints having software that is capable of receiving push messages from a push initiator, where the push agent may process the push messages and request push content). The push initiator may transmit a push message using an HTTP “POST” method to the endpoint's push agent. Also, in a pull operation, the endpoint may request a target URI of the push content from a trusted push server (e.g., a server, including a Tomcat Web Server) serving push content and conforming to specific security settings that may be established by a TPSLIST parameter in a script file, and the server may also be the same server as the push initiator where the push content is hosted (e.g., the PPE). In a pull operation, the push content may be a WML file or an XML file with tags that instruct the endpoint to do one or more of the following: transmit an RTP audio stream, receive an RTP audio stream, display paging session updates, and subscribe with the PPE.

Further, Received Audio Push Content may be sent with one of two priorities: normal or barge. Table 1, shown below, shows the result of receiving another Receive Audio push or a Transmit Audio push while a Receive Audio push is playing, depending on the push priorities.

TABLE 1

| This Audio | With this | | This Audio | With this |
|---|---|---|---|---|
| Push Type | Priority | Action | Push Type | Priority |
| Receive | Normal | DOES NOT | Receive | Normal |
| | | interrupt | | |
| Receive | Barge-in | DOES interrupt | Receive | Normal |
| Receive | Barge-in | DOES interrupt | Receive | Barge-in |
| Transmit | Normal | DOES NOT | Receive | Normal |
| | | interrupt | | |
| Transmit | Barge-in | DOES interrupt | Receive | Normal |
| Transmit | Barge-in | DOES interrupt | Receive | Barge-in |

In embodiments, a receive type push (including multicast type pushes applicable to IP phones) must be a valid XML file that contains a valid <Response> tag. The valid <Response> tag must contain a valid <Audio> tag, and the <Audio> tag must contain a <Url> tag with an href attribute that begins with “RTPRx://”. Thus, a special XML file for RTP streaming must initiate the Receive Audio push, and to be considered valid, the xml file must contain a valid <Response> tag that contains a valid <Audio> tag. Also, for multicast receive audio pushes, the RTP stream may be checked while playing to ensure that it is actually being streamed from the “remote_ip_address” of the transmitter indicated in the href attribute. An example of a valid <Response> tag that contains a valid <Audio> tag is shown as follows:

```
<?xml version=″1.0″?>
<Response>
  <Audio packetsize=”10|20|30|40|50|60” codec = “PCMU | PCMA”>
    <AudioTimer value=″30″/>
    <Url href=”RTPRx://remote_ip_address:remote_port”/>
    <Promptline>
      This text goes on the Prompt Line
    </Promptline>
  </Audio>
</Response>
```

In addition, each <Response> can contain only one <Audio> tag with the following attributes: an attribute of codec, with a value of PCMU|PCMA, which has silence suppression on with G.711 Annex A (no CID frames μ-law|A-law and default is PCMU; or an attribute of packetsize, with a value of 10|20|30|40|50|60 (milliseconds), which has a default of 20 milliseconds; or an attribute of <Promptline>, which provides the prompt line text to accompany the Audio Interrupt Screens. Each <Audio> tag must contain one valid <Url> tag and may contain one <AudioTimer> tag and/or one <Promptline> tag and the <AudioTimer> tag is used as an inter-packet timer.

Such a timer may be set every time a packet is received. After an administrable duration where no packets are received, the RTP stream is terminated. This tag has the following attributes: an attribute of value, a value of X (seconds), with a default of 30 seconds and a range of 5 to 30 seconds.

Each <Url> tag consists of information for the RTP streaming server (Multicast Group Address) and the local receive port of the telephone. If the <Url> tag has an unspecified format, the push will be terminated. A valid <Url> tag has the following attributes: an attribute of href, and a value of URI string, which is a URI to specify or control the RTP stream. A RTP streaming URI format is RTPRx://URI:port, with an IP address of the URI of the Multicast Group Address, and a port of RTPRx, which denotes “Receive” by the endpoint, nd the port number is separated by a colon. This is the receive port number or rtpLPort value from the GET request. For multicast, the RTPRx URI must be that of the server or endpoint transmitting (or streaming) audio.

The following reserved URIs can be used in the href attribute to control an audio stream: reserved URIs of RTPRx://STOP, which can be used to stop an audio streaming on the receive end. To be successful, all Push requests that result in sending the RTPRx://STOP must have a barge priority. To maintain an audio quality during the streaming we use the packet size of 20 ms. For example, if an audio stream originator wanted to explicitly stop an audio stream, the following would be sent in new Push Content:

```
<!- Following is the XML Push Request Message sent as a POST request
embedded as part of form data -->
XMLData = <?xml version=″1.0″?>
<Push type=“audio” mode=“barge”>
  <go href=“http://trusted_push_server/stop_audio.xml” method=“get”>
  </go>
</Push>
<!-The message below is from the Push Content file called
“stop_audio.xml” from above
go href URI -->
<?xml version=″1.0″?>
<Response>
  <Audio>
    <Url href=”RTPRx://STOP”>
  </Audio> <
</Response>
```

The paging system 200 uses various interface components to accomplish the user and group management functions and messaging functions described herein. For example, the paging system 200 uses database management and interface programming including JDBC/Hibernate 232, which is a Java-based data access technology that is an API for the Java programming language that defines how a client may access a database, providing methods for querying and updating data in a database; and PostgreSQL, which is an object-relational database management system for multiple platforms including Linux, FreeBSD, Solaris, Microsoft Windows and Mac OS X.

In embodiments, the endpoints (e.g., 210A and 210N) can send the request to an IP phone application (e.g., using management portal 216 and GWT/package UI 218 to send the request to device N 210N or using IP phone web application 212 and struts/USP/WML component 214 to send the request to device A 210A), and group information including which multicast group to join. Also, the information may be available to user 208A via device A 210A in the message posted by the IP phone web application 212. Once the endpoint is aware of which multicast group it may join, and upon receiving the multicast message, it can send a join request to join a multicast group such that the IP packet is properly routed. Thus, in a multicast group concept, the initiating endpoint sends the RTP information to the multicast group requesting the receiving endpoints to join to the multicast group. Thus, embodiment disclosed herein advantageously enable the use of existing components to provide new real-time messaging solutions; for example, changes to existing paging systems for IP endpoints allow registration of a multicast address without necessitating other changes on the phone. For example, the present disclosure advantageously provides a server or server application (e.g., an application gateway) that can send RTP audio messages such that any phone that can receive a RTP is able to play the real-time message. In addition, because multicast groups are defined on the server, users (such as 206A and 206N) and/or endpoints (such as 210A and 210N) may determine which endpoints to send a real-time message to as a group. This advantageously allows the real-time message to be delivered only to specific endpoints, and thereby avoids flooding all endpoints with a message. Further, overlaid architecture as described herein advantageously provides improved redundancy and reliability so that even if a call server or gateway application fails, the paging system 200 still has the ability to provide the real-time messages. In fact, once endpoints in the system have been registered (even only once), the paging system 200 has the ability to send out real-time messages, including the ability to send out multi-modal real-time messages.

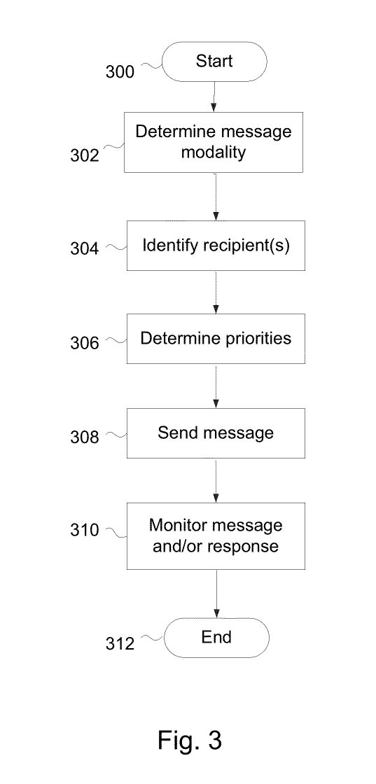

FIG. 3 is a flowchart according to an embodiment of the present disclosure. In FIG. 3, the process starts at step 300. In step 302, the sender determines the message modality. For example, the sender may determine that they want to send a real-time voice page. The sender can use a device connected to the paging system server to send the message in real-time.

In step 302, the sender identifies the recipient(s) of the message. For example, if a severe weather event is forecast to impact a certain area of a work campus with flash flooding, the sender may choose a group of users to receive the message whose workspaces are located in a building forecast to be impacted by the flooding. The sender may also determine the present location of other users within the building using their presence status, and include these users as recipients for the message. Further, the sender may specify that the recipients whose presence status indicates that they are currently using their desktop computers receive the real-time message through the speakers of their desktop computers, and that recipients who are not currently using a computer receive the message through the speakerphone of their mobile device. In addition, the sender may choose to send an image of the current radar and storm warnings in conjunction with the real-time message to recipients who are currently using their desktop computers. Still further, the sender may specify that recipients whose presence status shows that they are in a meeting, that these users receive the real-time message through a broadcast over speakers in the room connected by the building's previously existing broadcast system. Recipients who are currently engaged in a phone conversation may have their conversation interrupted by the higher priority incoming real-time message.

In step 306, the sender determines the priorities of the message. For example, the sender may set the highest priority of the message for people whose current location is in the building to be impacted by the flash flooding. Also, the sender may choose to send the message to users who are not currently located in the building, but who have workspace in the building, and to send the message to these users with a lower priority.

In step 308, the sender sends the message. As discussed previously, the message is a real-time audio message. Thus, the sender may send the message by speaking into the mobile device, and the recipients will hear the sender speaking the message in real-time through their respective receiving devices (e.g., their mobile device speaker, their mobile device speakerphone, their desktop computer speakers, or the broadcast system speakers).

In step 310, the sender monitors the message and/or the recipient's responses. In embodiments, the sender may monitor the status using an application on the mobile device. For example, the sender may monitor the presence status of the recipients while the message is sent. The sender may also monitor a status of the message and whether the recipients choose to receive the message or not. In embodiments, the application may dynamically update the message session, so that the sender receives an updated status that the message is being played on certain recipient's audio devices, and if a recipient stops receiving the message at any point, the sender is notified via the dynamic update. The sender may take additional actions based on the recipient's actions and message status. In step 312, the process ends.

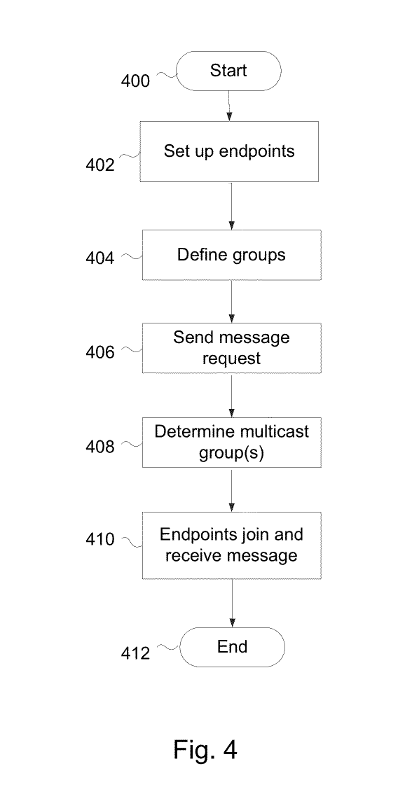

FIG. 4 is a flowchart according to an embodiment of the present disclosure. In FIG. 4, the process starts at step 400. In step 402, an administrator sets up a multitude of endpoints using IP addresses and phone numbers, for example, to differentiate between various endpoint devices. Endpoint devices may include pre-existing endpoints in the pre-existing communication system, for example, enterprise endpoints such as phones, softphones (on personal computers, tablets, etc), and the endpoints may have only a simple application that registers on the application gateway. In embodiments, the administrator sends a request to the user at the endpoint, via a gateway application and the VIP, to register the endpoint. The endpoints may then register with the application gateway using a virtual IP address system. Also, for example, endpoints may be registered by adding identifying information about the endpoint to a list (e.g., the IP address of the endpoint, and/or the physical location of the endpoint). Further, various address types may be linked to various properties of the endpoint (e.g., its communication mode), and these various addresses may be included within a group.

In embodiments, there are more than one of each of the gateway application and VIP to provide redundancy in the system and enable the messaging system to continue operations in the event of any issues with the pre-existing equipment (e.g., the call server) or a gateway application or VIP. In particular, if the call server fails, the endpoints have IP addresses, thereby enabling the paging gateway to send multicast audio messages to the IP telephone endpoints even though it can't send them through the failed call server.

In step 404, a user defines multicast groups to which to send a real-time message. In step 406, the user sends the real-time message request. When the user sends the real-time message request, in step 408, the application gateway determines the multicast group(s), and asks the endpoint to join in the multicast group. In embodiments, when determining a multicast group, the initiating user may select a pre-determined group from a list of available groups, and may also select users within the group to which to send the message. In step 410, various endpoints join in the multicast group and the VIP and/or application gateway create optimal distribution paths for the message sent to a multicast destination address. In embodiments, the creation of the optimal distribution paths may advantageously reduce network traffic and address scalability. In step 412, the initiating user sends the real-time message, with the receiving endpoints receiving it in real-time. In embodiments, the behavior of the receiving endpoint may depend on various factors. For example, if the receiving user's endpoint is idle, the message is automatically answered and the message is heard on the speakers of the intended recipient without any intervention of the recipient. In addition, groups or users may be configured with different priorities, and these may provide different levels of paging access. Depending on the priority, a defined action may be taken as described herein. In step 414, the process ends.

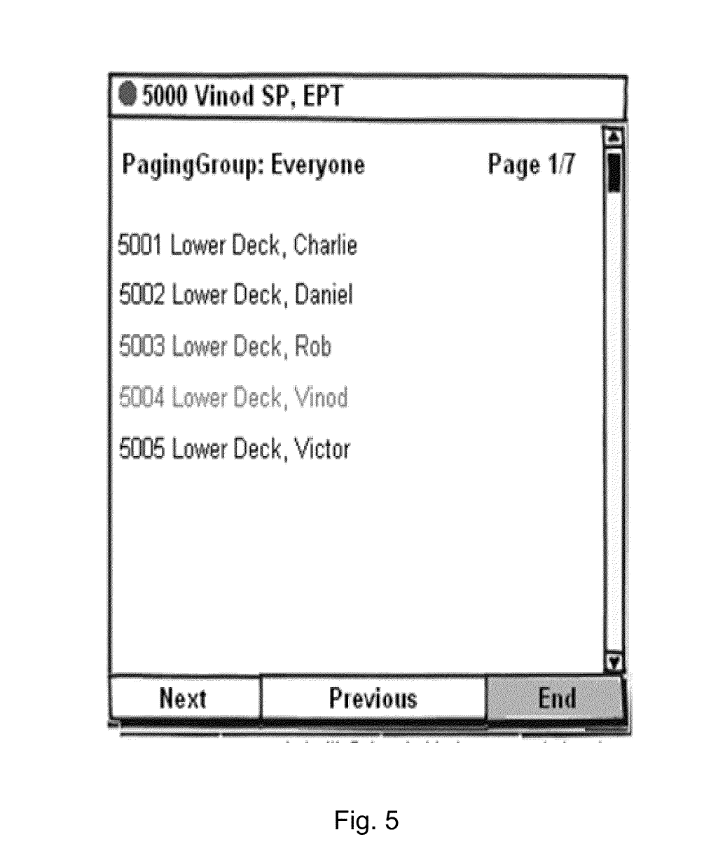

FIG. 5 depicts a screenshot from an exemplary method of the disclosure. In particular, FIG. 5 shows a screenshot of an application for real-time messaging. In particular, the screenshot is a window showing group paging. The top line of the window shows the sending user's name (Vinod SP) and location (EPT); the middle of the window lists the members of the group selected (PagingGroup: Everyone) and the page number, and the bottom of the window is the menu. In this window, the circular indicator next to the sending user's name may be colored to indicate a priority associated with the sending user. In addition, the users in the group may have the text of their names and information in different colors to indicate a priority associated with each user.

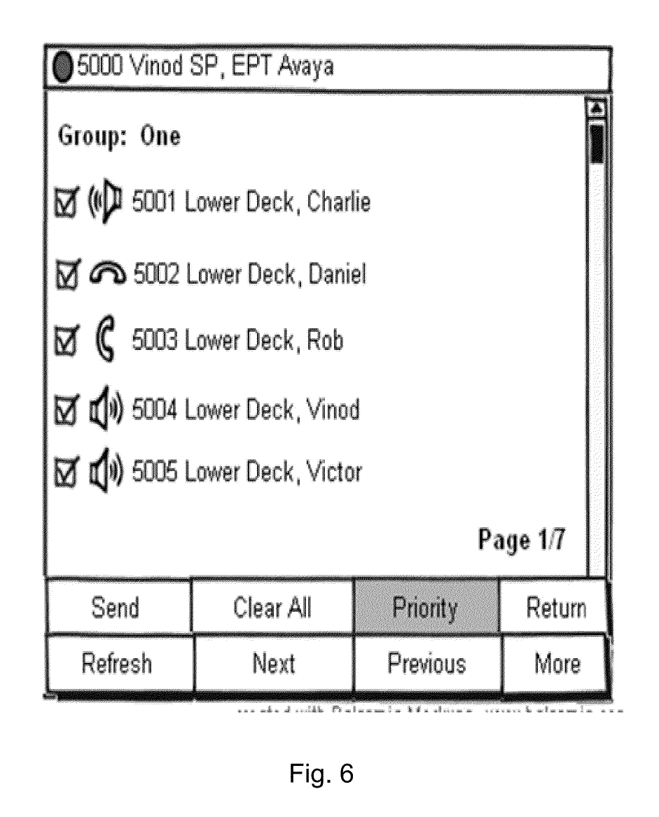

FIG. 6 depicts a screenshot from an exemplary method of the disclosure. In particular, FIG. 6 shows another screenshot for initiating paging using priority, where the users' presence status is indicated to the sending user. In FIG. 6, the group of users is Group: One, and the sending user is viewing each of the user's locations and status regarding whether they are receiving a page, sending a page, engaged in a phone call, or not engaged on a phone call. The menu at the bottom of this window indicates options to send a page, refresh the information on the screen, to clear or select all, to set a priority, to return back to the homepage, and to display more options.

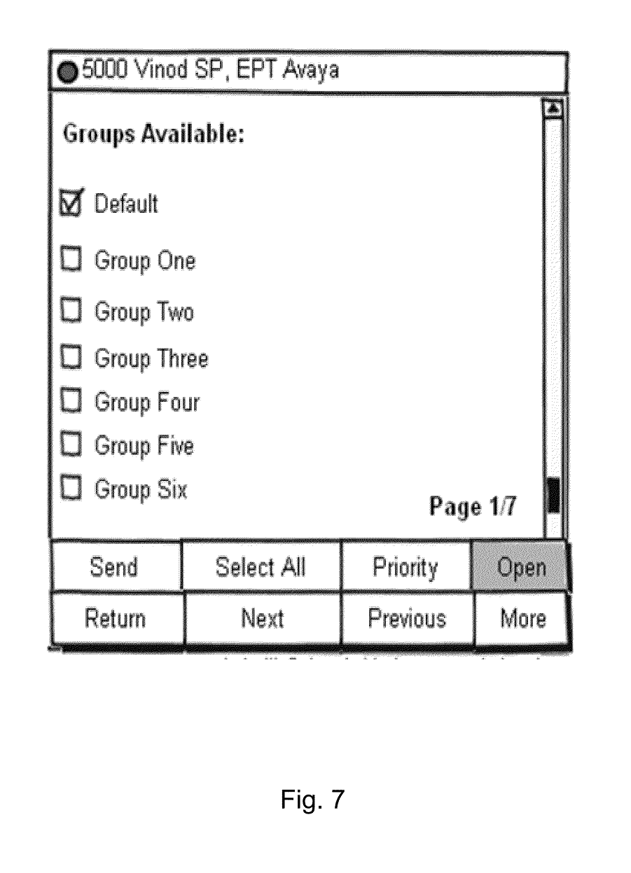

FIG. 7 depicts a screenshot from an exemplary method of the disclosure. In particular, FIG. 7 shows a page senders screen to select a single group or multiple groups for the message. In particular, this window indicates that all of the members are part of the default group due to the checkmark. Further, in embodiments, this screen is the homepage for the sending user to compose a real-time page.

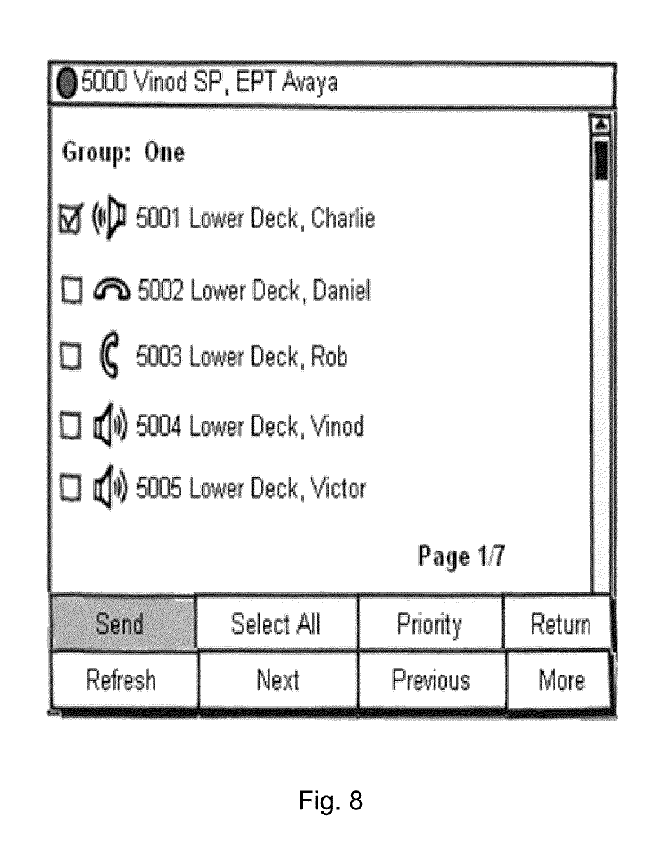

FIG. 8 depicts a screenshot from an exemplary method of the disclosure. In particular, FIG. 8 shows users in Group: One, with one user selected (Charlie). Charlie is currently sending a page; so the sending user knows that upon sending a real-time message with a higher priority than the page Charlie is currently engaged in, Charlie's current page will be interrupted to allow the higher priority message to be transmitted to Charlie. Also, Charlie may select whether or not to allow the higher priority message to play, and the sending user may view whether Charlie is listening to the message or not. This window also shows the presence status of the users (e.g., on hook, off hook, page in (group in), or page out (group out)) for their endpoints.

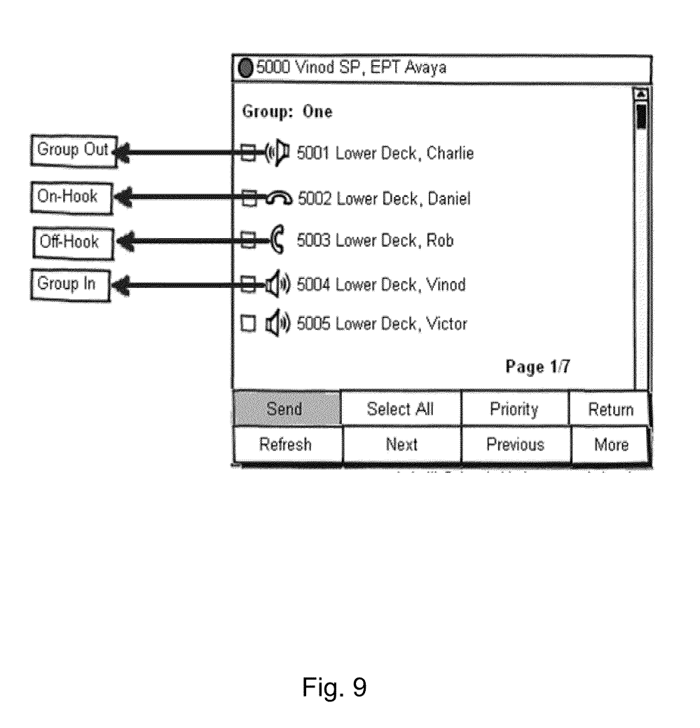

FIG. 9 depicts a screenshot from an exemplary method of the disclosure. In particular, FIG. 9 shows the ability to dynamically update the paging session status for the sending and receiving endpoints.

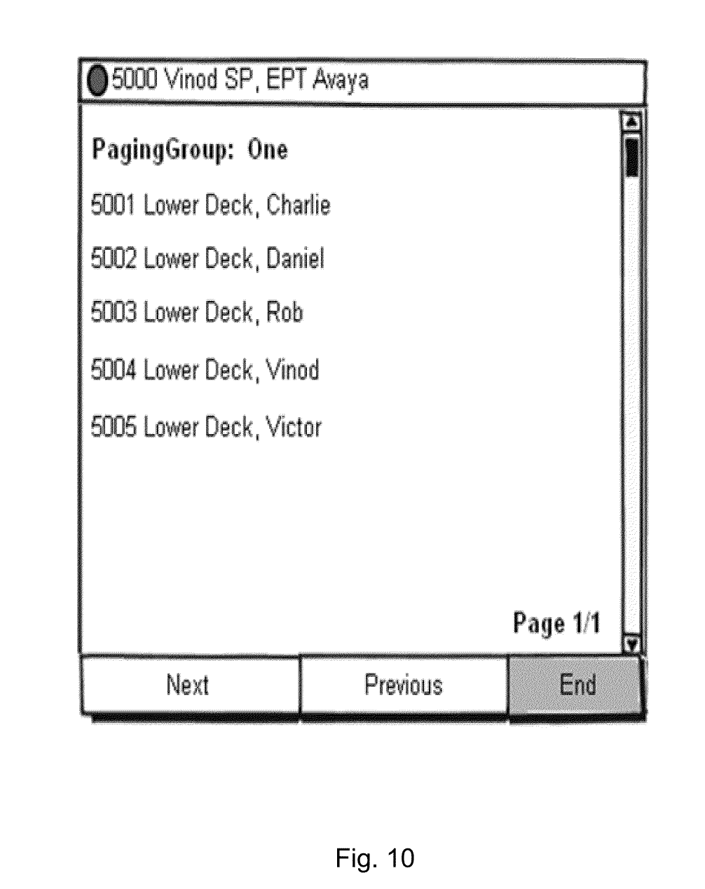

FIG. 10 depicts a screenshot from an exemplary method of the disclosure. In particular, FIG. 10 shows that all the users are receiving the real-time message because all of the users' information is in the same color font, for example.

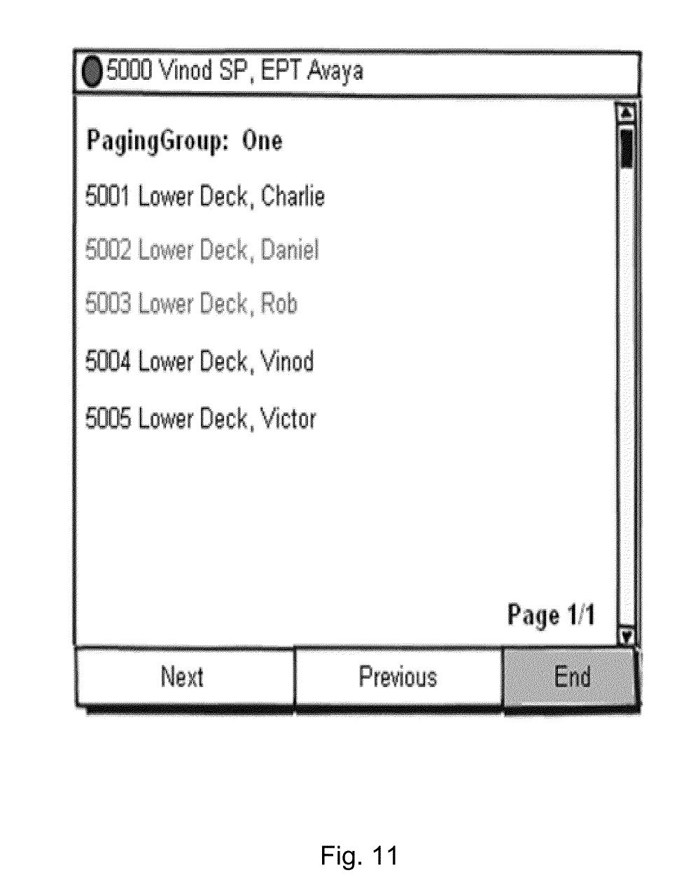

FIG. 11 depicts a screenshot from an exemplary method of the disclosure. In at particular, FIG. 11 shows that some of the users are receiving the page. Users Daniel and

Rob are in a different color (grey instead of black) because they have been disconnected. Thus, in embodiments, when a page or message is initiated, the status of receiving users may be shown by their information being in a certain color (e.g., black) font. Then, the color of the font may dynamically update to indicate a change in their status, such as being disconnected.

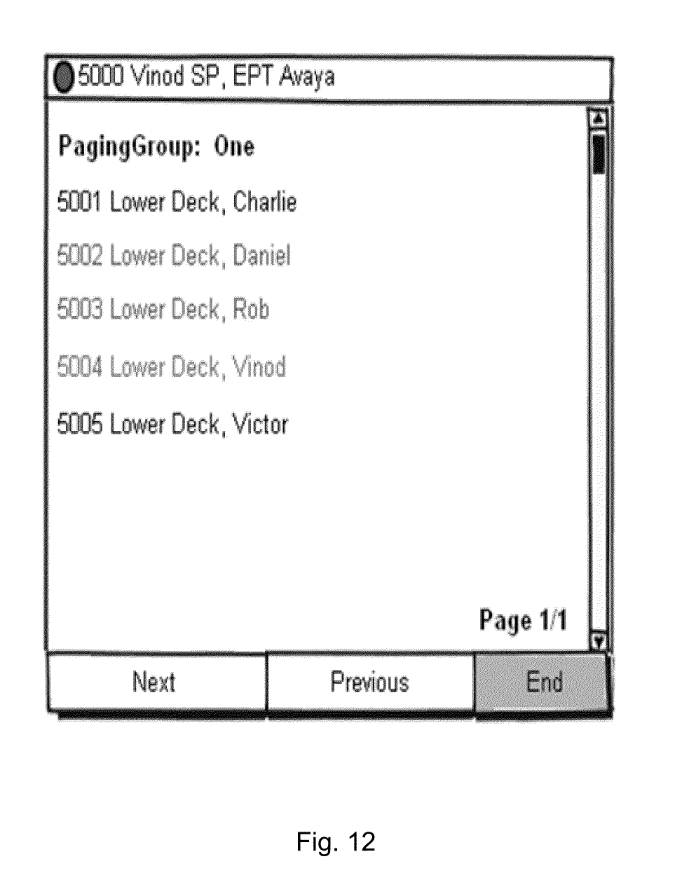

FIG. 12 depicts a screenshot from an exemplary method of the disclosure. In particular, FIG. 12 shows users in lighter grey font to indicate various statuses. For example, users Daniel, Rob, and Vinod are in a lighter grey font and this may indicate that they have decided to terminate their session, or that they were bumped from the session due to receiving a different, higher priority, session. Further, the colors of the font may be any color, and many also vary in other aspects (e.g., font size, shapes, etc.) to indicate various statuses.

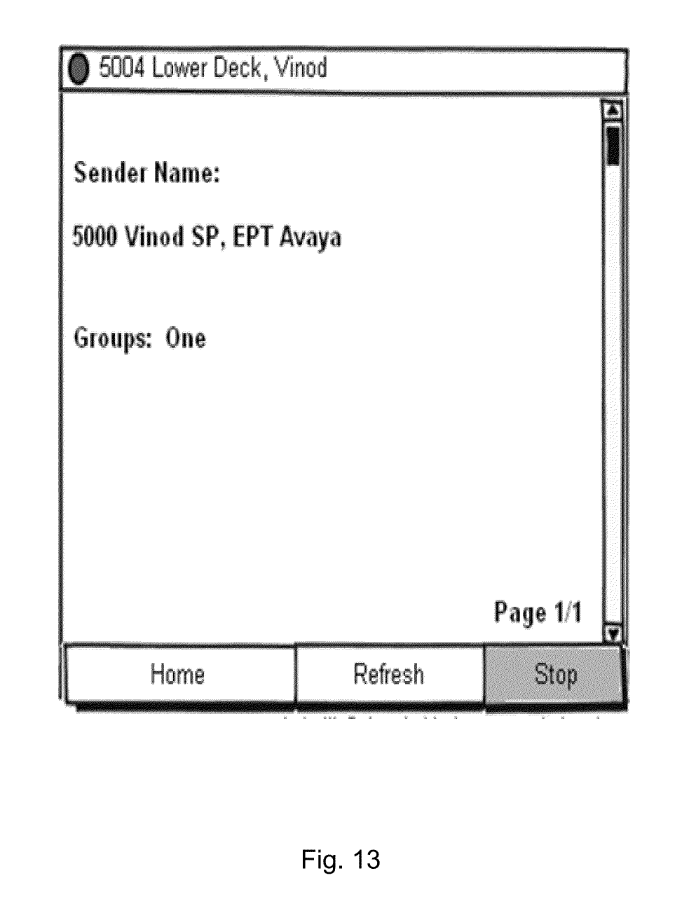

FIG. 13 depicts a screenshot from an exemplary method of the disclosure. In particular, FIG. 13 shows a window for a receiving user that allows them to stop receiving the message on that endpoint. In addition, this window shows the sending user's information and that a single group (Group: One) was paged.

The exemplary systems and methods of this disclosure are described in relation to a distributed processing network. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show certain of the various components of the system as being collocated, certain components of the system can be located remotely, at distant portions of a distributed network, such as a LAN and/or the Internet, or within a dedicated system. Thus, it should be appreciated, that the components of the system can be combined in to one or more devices, such as a communication device rather than a server, or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of other variations and modifications of the disclosure can be used. It would be possible to provide for some features of the disclosure without providing others.

For example in one alternative embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, includes components, methods, processes, systems and/or apparatus substantially as depicted and described herein, including various embodiments, subcombinations, and subsets thereof. Those of skill in the art will understand how to make and use the present disclosure after understanding the present disclosure. The present disclosure, in various embodiments, includes providing devices and processes in the absence of items not depicted and/or described herein or in various embodiments hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments for the purpose of streamlining the disclosure. The features of the embodiments of the disclosure may be combined in alternate embodiments other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the disclosure.

Moreover, though the description of the disclosure has included description of one or more embodiments and certain variations and modifications, other variations, combinations, and modifications are within the scope of the disclosure, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method, comprising:
sending a real-time message to a recipient, wherein the sending is accomplished using a pre-existing communication system in communication with at least one of multiple application gateways or multiple networks.

2. The method of claim 1, further comprising: prior to sending the message, identifying the recipient, wherein the recipient comprises one or more members of a target audience to receive the message.

3. The method of claim 2, wherein identifying the recipient is based on a property of the recipient.

4. The method of claim 1, wherein at least one of the message or the recipient has a priority.

5. The method of claim 4, wherein the priority is based on a characteristic of at least one of the message or the recipient.

6. The method of claim 1, further comprising: notifying the sender of a status of the message.

7. The method of claim 4, wherein the priority is a high priority, and further comprising a second message having a low priority, wherein the message is sent after the second message or at the same time as the second message, and wherein the recipient receives the message prior to the second message.

8. The method of claim 1, wherein the recipient does not receive the message in real-time, and wherein the sender is notified of the recipient not receiving the message in real-time.

9. The method of claim 1, wherein the application gateway is front-ended by at least one virtual IP address.

10. The method of claim 1, wherein the message is an audio message in addition to at least one of: a text message, an image, and a video.

11. A computer readable medium having stored thereon computer executable instructions, the computer executable instructions causing a processor to execute a method for sending a real-time message, the computer readable instructions comprising:
instructions to send the message to a recipient, wherein the sending is accomplished using a pre-existing communication system in communication with at least one of multiple application gateways or multiple networks.

12. A system, comprising:
a paging engine;
a first application gateway; and
an administrative portal;
wherein the paging engines, the first application gateway, and the administrative portal are configured to send a real-time message to a recipient, wherein the sending is accomplished using a pre-existing communication system in communication with at least one of multiple application gateways or multiple networks.

13. The system of claim 12, further comprising: prior to sending the message, identifying the recipient, wherein the recipient comprises one or more members of a target audience to receive the message.

14. The system of claim 12, wherein identifying the recipient is based on a property of the recipient.

15. The system of claim 12, wherein at least one of the message or the recipient has a priority.

16. The system of claim 15, wherein the priority is based on a characteristic of at least one of the message or the recipient.

17. The system of claim 12, further comprising: notifying the sender of a status of the message.

18. The system of claim 15, wherein the priority is a high priority, and further comprising a second message having a low priority, wherein the message is sent after the second message or at the same time as the second message, and wherein the recipient receives the message prior to the second message.

19. The system of claim 15, wherein the application gateway is front-ended by at least one virtual IP address.

20. The system of claim 15, wherein the message is an audio message in addition to at least one of: a text message, an image, and a video.
